(19) United States
(12) Patent Application Publication
(10) Pub. No.: US 2010/0248795 A1
(43) Pub. Date: Sep. 30, 2010

(54) INFORMATION PROCESSING TERMINAL

(75) Inventors: Kenta Sugimori, Kawasaki (JP); Manabu Matsushima, Kawasaki (JP); Yoshifumi Kajiwara, Kawasaki (JP); Haruyoshi Yada, Kawasaki (JP); Takehisa Ishikawa, Kawasaki (JP); Hiroshi Kubo, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/749,099

(22) Filed: Mar. 29, 2010

(30) Foreign Application Priority Data
Mar. 31, 2009 (JP) 2009-87595

(51) Int. Cl. H04W 88/02

(52) U.S. Cl. 455/575.1

(57) ABSTRACT

An information processing terminal includes a first housing, and a second housing which is movably connected to the first housing via a connection mechanism, wherein the connection mechanism includes a guide pin which is protrusively formed on a side of the first housing, and wherein the first housing includes a guide groove which controls a moving direction of the first housing and the second housing by being engaged with the guide pin, and a dust-proof sheet which seals the guide groove.

### CROSS-REFERENCE TO RELATED APPLICATIONS

This application is based upon and claims the benefit of priority of the prior Japanese Patent Application No. 2009-087595, filed on Mar. 31, 2009, the entire contents of which are incorporated herein by reference.

1. Field

The present invention relates to an information processing terminal. The present invention relates to, for example, an information processing terminal that movably connects a first housing to a second housing via a connection mechanism.

2. Background

In recent years, there has been a wide use of information terminal devices such as mobile phones which are rotatable or slidable by connecting, via a given connection mechanism, a fixed side housing having an operation unit such as keys to a movable side housing having a display unit such as a display. For example, a slide type mobile phone aims to be compact because the movable side housing is slid relative to the fixed side housing, and a state of the mobile phone is changeable between a closed state and an open state. A rotatable mobile phone aims to improve visibility of the display unit by rotating the movable side housing to the fixed side housing.

The information terminal device movably connecting the fixed side housing and the movable side housing may be provided with guide grooves in one housing and provided with guide pins slidably engaged with the guide grooves in the other housing or with the connection mechanism. The guide grooves and the guide pins are provided to enable the fixed side housing and the movable side housing to move smoothly and to prevent the fixed side housing and the movable side housing from being damaged when the fixed side housing and the movable side housing are moved in the wrong direction.

[Patent Document 1] Japanese Laid-open Patent Publication No. 2008-103989

However, as for an information terminal device having guide grooves and guide pins as described in a conventional technique, there has been a problem that grit and dust enter an inner part of the information terminal device from the guide grooves. The entry of grit and dust may cause operational errors of the information terminal device due to a short circuit or the like, so that there has been a demand to solve the problem.

### SUMMARY

According to an aspect of the invention, an information processing terminal includes a first housing, and a second housing which is movably connected to the first housing via a connection mechanism, wherein the connection mechanism includes a guide pin which is protrusively formed on a side of the first housing, and wherein the first housing includes a guide groove which controls a moving direction of the first housing and the second housing by being engaged with the guide pin, and a dust-proof sheet which seals the guide groove.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1A is a plan view of a closed state of a mobile phone,

FIG. 1B is a plan view of an open state of a mobile phone,

FIG. 1C is a plan view of a rotating state of a mobile phone,

FIG. 2 is an exploded perspective view of a mobile phone,

FIG. 3 is an exploded perspective view of a connection mechanism,

FIG. 4 is a diagram illustrating a closed state of a mobile phone,

FIG. 5A is a diagram illustrating a state of sliding start time of a mobile phone,

FIG. 5B is a plan view illustrating an open state of a mobile phone,

FIG. 6A is a diagram illustrating a state of rotating start time of a mobile phone,

FIG. 6B is a plan view illustrating a rotating state of a mobile phone, and

FIG. 7 is an A-A sectional view of the mobile phone illustrated in FIG. 4.

### DESCRIPTION OF THE EMBODIMENTS

With reference to the figures, detailed description will be made of embodiments of an information processing device disclosed in the present invention. In the following embodiments, the information terminal device disclosed in the present invention will be described as a mobile phone, for example. The information terminal device disclosed in the present invention may be various devices other than a mobile phone, such as a personal computer, Personal Digital Assistants (PDA), a portable video game machine, and the like.

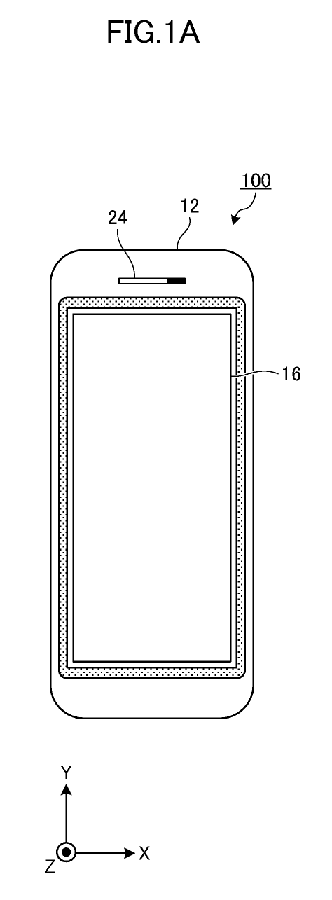

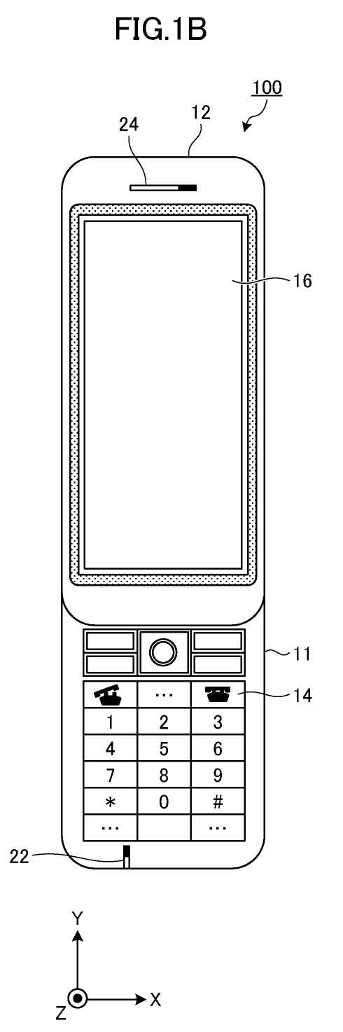

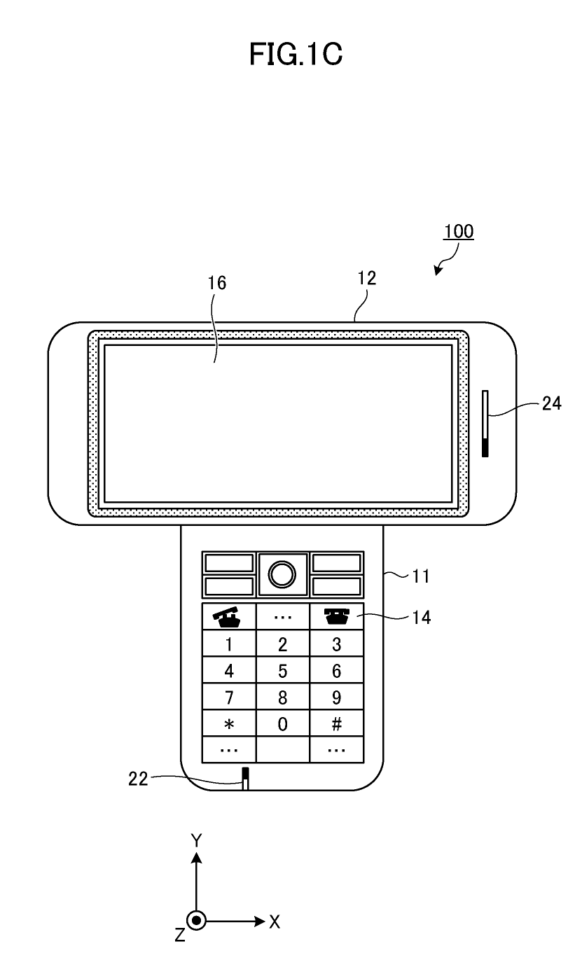

With reference to FIG. 1A to FIG. 1C, description will be made of a mobile phone 100 according to the present embodiment. FIG. 1A is a plan view illustrating a closed state of the mobile phone 100. FIG. 1B is a plan view illustrating an open state of the mobile phone 100. FIG. 1C is a plan view illustrating a rotating state of the mobile phone 100.

As illustrated in FIG. 1A to FIG. 1C, the mobile phone 100 includes a fixed side housing 11 as a housing on an operation unit side and a movable side housing 12 as a housing on a display unit side, and movably connects the movable side housing 12 to the fixed side housing 11 via a connection mechanism 50 described below. The fixed side housing 11 is provided with an operation unit 14 having operation buttons and a microphone 22 for voice communication. The movable side housing 12 is provided with a display panel 16 and a speaker 24 for listening.

The connection mechanism 50, which is provided between the fixed side housing 11 and the movable side housing 12, makes the fixed side housing 11 and the movable side housing 12 slidably and rotatably connected with each other. By sliding or rotating the movable side housing 12 to the fixed side housing 11, the mobile phone 100 may change the state to the closed state illustrated in FIG. 1A, the open state illustrated in FIG. 1B, or the rotating state illustrated in FIG. 1C

The closed state illustrated in FIG. 1A is a state where the fixed side housing 11 overlaps the movable side housing 12 in the largest overlapping area. In the closed state, the length in a longitudinal direction of the mobile phone 100 is longest. The mobile phone 100 is set to the closed state, for example, when being carried or when performing a simple function such as viewing a transmission and reception history without using the operation unit 14.

The open state illustrated in FIG. 1B is a state where the fixed side housing 11 and the movable side housing 12 are overlapped in the smallest overlapping area. In the open state, the length of the fixed side housing 11 in the longitudinal direction is the longest. In the open state, the operation unit 14 of the fixed side housing 11 is exposed. The mobile phone 100 is set to the open state, for example, when a user performs operation for making a call or writing an outgoing mail by using the operation unit 14.

The rotating state illustrated in FIG. 1C is a state where the movable side housing 12 rotates relative to the fixed side housing by substantially 90 degrees from the open state illustrated in FIG. 1B. When the movable side housing 12 rotates by 90 degrees, the display panel 16 is turned perpendicular to the fixed side housing 11. Thus, the mobile phone 100 is set to the rotating state, for example, when a user watches a video or views a web page.

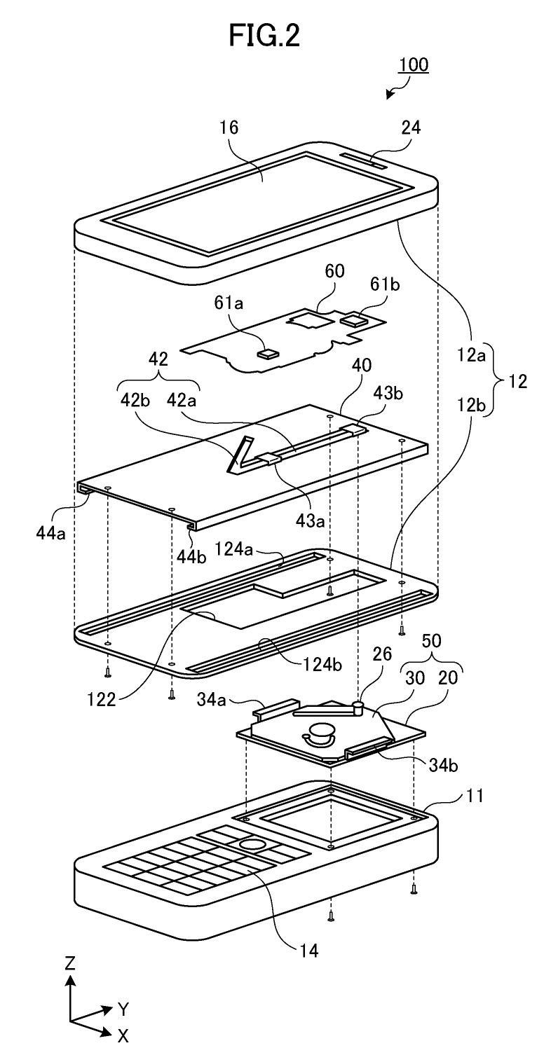

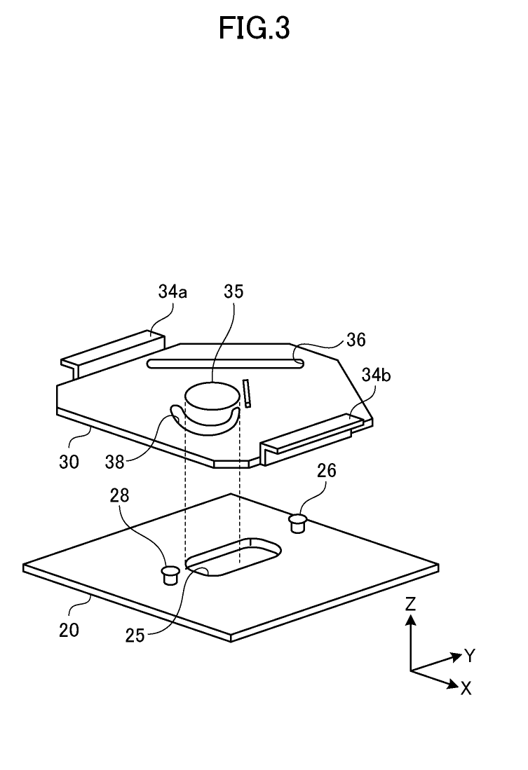

With reference to FIG. 2 and FIG. 3, description will be made of a configuration of the mobile phone 100. FIG. 2 is an exploded perspective view of the mobile phone 100. As illustrated in FIG. 2, the mobile phone 100 includes the fixed side housing 11, the movable side housing 12, and the connection mechanism 50. FIG. 3 is an exploded perspective view of the connection mechanism 50. As illustrated in FIG. 3, the connection mechanism 50 includes a base plate 20 and a swing plate 30.

The movable side housing 12 includes a main body unit 12a, a base bottom unit 12b, and a slide plate 40. The main body unit 12a includes the display panel 16 and the speaker 24 for listening, and also includes a backlight used to display an image on the display panel 16, an electronic substrate that performs various controls, and wires used to transmit signals and electric power, and the like in the inside thereof.

The base bottom unit 12b has a surface, which is a surface of the movable side housing 12, facing the fixed side housing 11. The base bottom unit 12b fixes the slide plate 40 inside the movable side housing 12 with a screw and the like, that is, the opposite surface viewed from the fixed side housing 11.

The slide plate 40 includes slide guide members 44a and 44b that are formed in parallel to a direction in which the fixed side housing 11 and the movable side housing 12 are slid. The slide guide members 44a and 44b are exposed on the side of the fixed side housing 11 through holes 124a and 124b that are pierced and formed in parallel to the base bottom unit 12b.

The slide plate 40 includes a guide groove 42 that is formed by combining guide grooves 42a and 42b. The guide groove 42a is pierced and formed to have one end near the center of the slide plate 40 and have the other end near the outer circumference of the slide plate 40 in parallel to a direction in which the fixed side housing 11 and the movable side housing 12 are slid. The guide groove 42b is pierced and formed to have one end near the center of the slide plate 40 and to be extended in a direction different from that of the guide groove 42a.

The guide groove 42 is exposed on the side of the fixed side housing 11 through an opening 122 that is pierced and formed in parallel to the base bottom unit 12b. To improve machining accuracy and prevent deformation, the guide groove 42 is reinforced by bridge members 43a and 43b on the side of the fixed side housing 11 and the opposite side.

The size in the longitudinal direction of the guide groove 42a is determined, for example, by how much the fixed side housing 11 and the movable side housing 12 may be slid. The size of the guide groove 42b and the direction in which the guide groove 42b is extended are determined by, for example, the direction in which the fixed side housing 11 and the movable side housing 12 are rotated or the track of the rotation.

The base plate 20 of the connection mechanism 50 includes a guide groove 25, which is pierced and formed in an oblong shape near the center of the base plate 20, and guide pins 26 and 28 protrusively formed. The guide pin 26 is formed higher than the guide pin 28. The swing plate 30 of the connection mechanism 50 includes a circular axial hole 35 that is pierced and formed near the center of the swing plate 30, guide grooves 36 and 38 that are pierced and formed in a given form near the axial hole 35, and slide leg members 34a and 34b that are formed in parallel.

The swing plate 30 is rotatably connected to the base plate 20 on the axial hole 35 by the member (not illustrated) piercing through the guide groove 25 and the axial hole 35 in a state where the guide pin 26 is engaged with the guide groove 36 and the guide pin 28 is engaged with the guide groove 38. The angle and the direction in which the swing plate 30 is rotated are controlled by the guide grooves 36 and 38 that are engaged with the guide pins 26 and 28.

The swing plate 30 is slidably connected to the slide plate 40 in a state where the slide leg members 34a and 34b are engaged with the slide guide members 44a and 44b and where the guide pin 26 is engaged with the guide groove 42. The base plate 20 is fixed to the fixed side housing 11 with a screw and the like in a state where the surface opposite to the surface on which the guide pins 26 and 28 are formed is buried in a concave portion provided in the fixed side housing 11.

As for the mobile phone 100, the swing plate 30 is slidably connected to the movable side housing 12 and rotatably connected to the fixed side housing 11. As illustrated in FIG. 1A to FIG. 1C, the mobile phone 100 may be moved between three kinds of states: the closed state, the open state, and the rotating state.

Detailed description will be made of a structure in which the fixed side housing 11 and the movable side housing 12 are movable. Regarding the mobile phone 100, the guide pin 26 is engaged with the guide groove 42. This makes it possible to smoothly move the fixed side housing 11 and the movable side housing 12. By engaging the guide pin 26 with the guide groove 42, the movable direction is controlled. This may reduce or prevent the fixed side housing 11 and the movable side housing 12 form being moved in an inappropriate direction and damaged.

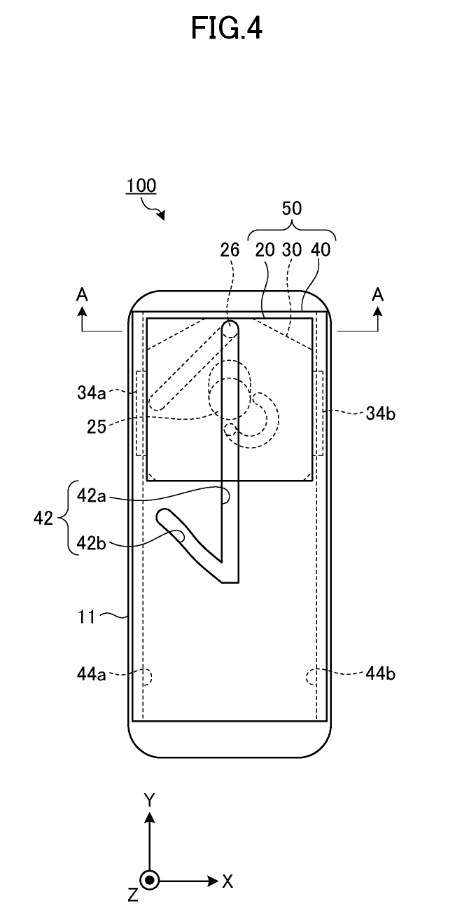

FIG. 4 is a diagram illustrating the closed state of the mobile phone 100. As illustrated in FIG. 4, in the closed state, the guide pin 26 comes into contact with one end of the outer circumference of the guide groove 42a.

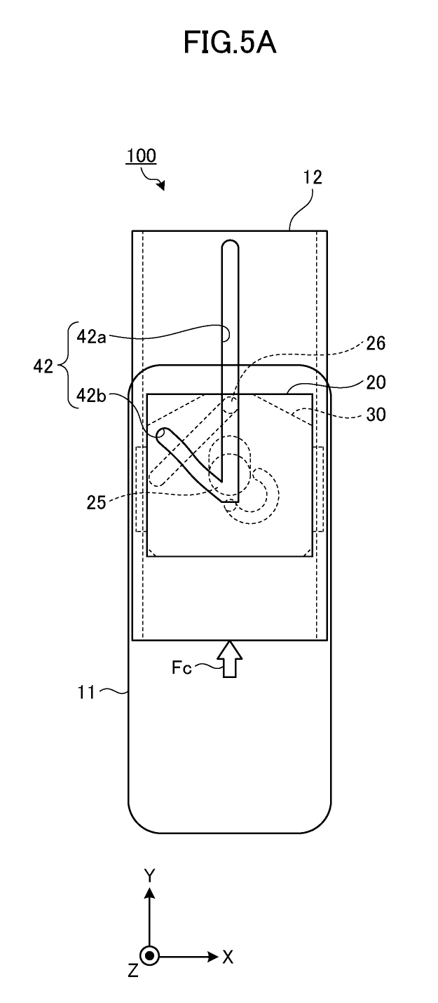

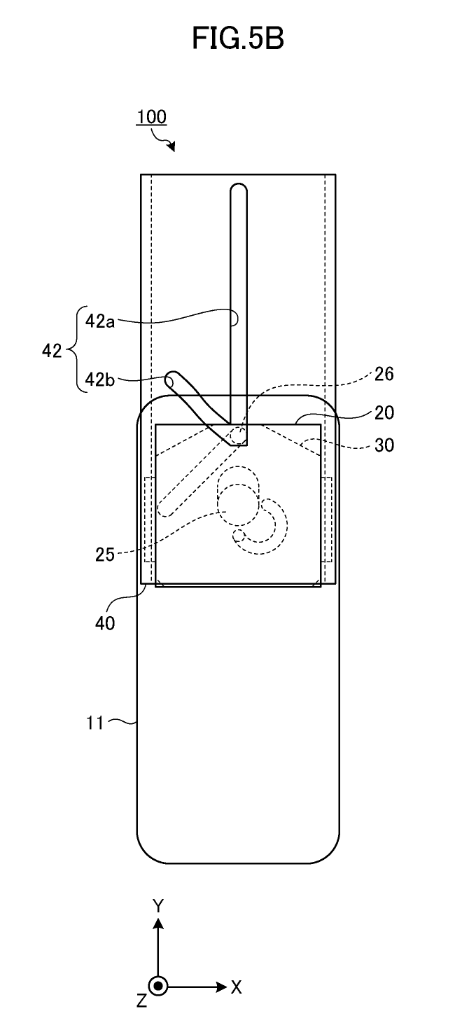

If an external force Fc that is used to slide the movable side housing 12 acts toward the movable side housing 12 from a downward direction in FIG. 4, the movable side housing 12 starts to slide as illustrated in FIG. 5A. Since the guide pin 26 is engaged with the guide groove 42a, the movable side housing 12 is controlled to slide in a straight direction.

The movable side housing 12 is in the open state as illustrated in FIG. 5B. In the closed state, the guide pin 26 comes into contact with one end of the central side of the guide groove 42a.

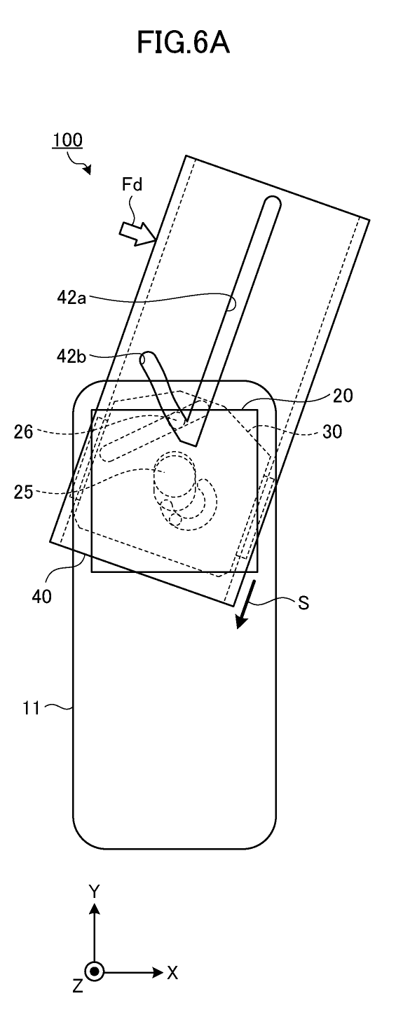

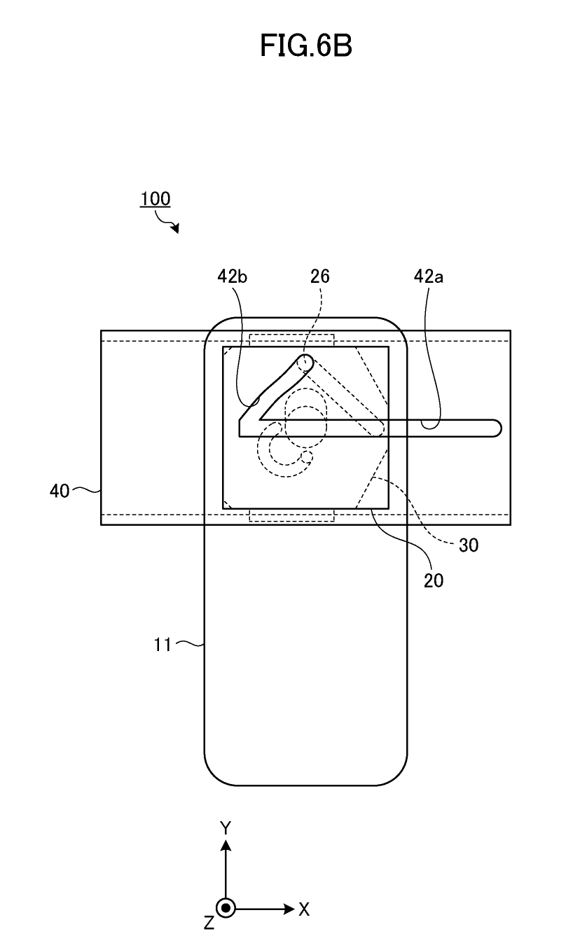

An external force Fd used to rotate the movable side housing 12 acts toward the movable side housing 12 from the left direction, and the movable side housing 12 starts to rotate as illustrated in FIG. 6A. When the guide pin 26 starts to enter the guide groove 42b, the movable side housing 12 is controlled in the rotating direction because the guide pin 26 is engaged with the guide groove 42b.

The movable side housing 12 is in the rotating state illustrated in FIG. 6B. In the rotating state, the guide pin 26 comes into contact with one end of the outer circumference of the guide groove 42b.

The guide groove 42 enables the fixed side housing 11 and the movable side housing 12 to move smoothly and helps in controlling the direction in which the fixed side housing 11 and the movable side housing 12 move so that the fixed side housing 11 and the movable side housing 12 are not damaged when moving.

However, when the guide groove 42 is exposed, grit and dust and the like may enter the guide groove 42. This may cause failures such as a short circuit of an electronic substrate inside the movable side housing 12. Regarding the mobile phone 100, the guide groove 42 is sealed from the inside of the movable side housing 12 with a dust-proof sheet 60 as illustrated in FIG. 2.

On the dust-proof sheet 60, convex parts 61a and 61b are formed in parts corresponding to the bridge members 43a and 43b. The convex parts 61a and 61b are formed by, for example, press forming. The dust-proof sheet 60 formed corresponding to a three-dimensional shape of the guide groove 42 may improve the dust-proof property.

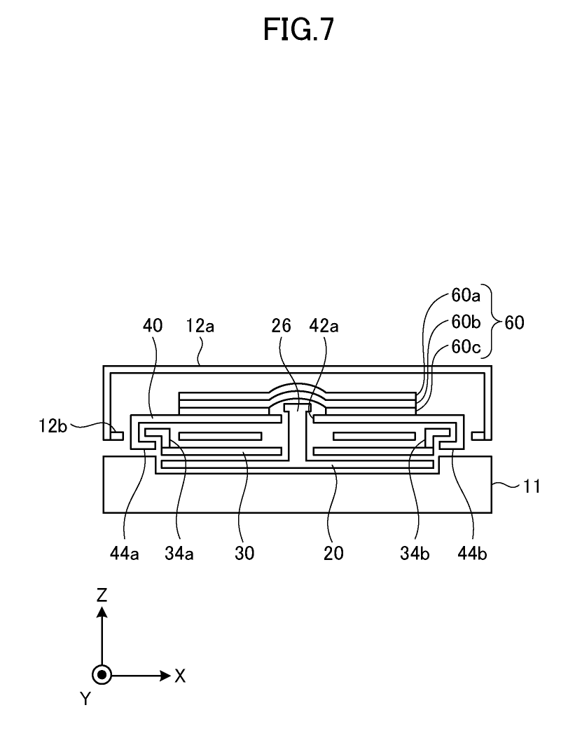

FIG. 7 is an A-A sectional view of the mobile phone 100 illustrated in FIG. 4. As illustrated in FIG. 7, the dust-proof sheet 60 is formed by overlaying a sliding sheet 60a, a light blocking sheet 60b, and an adhesive tape 60c, in order from the movable side housing 12 to the fixed side housing 11, over the slide plate 40.

The sliding sheet 60a has a superior sliding property and may be “NITTO No. 440” for example. The “NITTO No. 400” is Ultrahigh-molecular-weight Polyethylene Film No. 440, a product of NITTO DENKO CORPORATION. The movable side housing 12 includes various wires. The wires may be displaced by a force generated in association with a change of the form of the mobile phone 100. Use of the sliding sheet 60a on a part facing the internal part of the movable side housing 12 smoothly displaces the wires inside the movable side housing 12, so that disconnection of the wires may be reduced if not prevented.

The light blocking sheet 60b does not transmit light and may be “DIC LS-016H,” for example. As described above, the movable side housing 12 includes a backlight used to display an image on the display panel 16. By including the light blocking sheet 60b in the dust-proof sheet 60, it is possible to reduce if not prevent the light of the backlight from leaking from the guide groove 42. The dust-proof sheet 60 may also be provided with the light blocking property by applying light block printing.

The adhesive tape 60c is used to adhere the dust-proof sheet 60 to the slide plate 40. As illustrated in FIG. 7, the dust-proof sheet 60 is preferably formed in a shape in which the part in contact with the guide pin 26 is formed toward the inside of the movable side housing 12. If the part in contact with the guide pin 26 is formed toward the inside of the movable side housing 12, movement of the guide pin 26 may not be inhibited.

According to the present embodiment, the guide groove 42 is sealed from the inside of the movable side housing 12 with the dust-proof sheet 60. This may prevent grit and dust from entering the guide groove 42.

According to one of the embodiments of the information processing terminal disclosed in the present invention, an advantage of the present invention is to provide an information processing terminal having a dust-proof property.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing terminal comprising:
a first housing, and
a second housing which is movably connected to the first housing via a connection mechanism,
wherein the connection mechanism includes a guide pin which is protrusively formed on a side of the first housing, and
wherein the first housing comprises:
a guide groove which controls a moving direction of the first housing and the second housing by being engaged with the guide pin, and
a dust-proof sheet which seals the guide groove.

2. The information processing terminal according to claim 1, wherein the dust-proof sheet has a part which is formed toward an inner part of the first housing, the part being in contact with the guide pin.

3. The information processing terminal according to claim 1, wherein the dust-proof sheet is made from a material providing an inner side of the first housing with a sliding property.

4. The information processing terminal according to claim 1, wherein the dust-proof sheet includes a layer having a light blocking property.

5. The information processing terminal according to claim 1, wherein the dust-proof sheet is applied with light block printing.
